(19) United States
(12) Patent Application Publication
(10) Pub. No.: US 2018/0274479 A1
(43) Pub. Date: Sep. 27, 2018

(54) PROTECTIVE LAYER PREVENTING OXIDATION OF THE PISTON OF AN INTERNAL COMBUSTION ENGINE

(71) Applicant: FEDERAL-MOGUL NURNBERG GMBH, Nurnberg (DE)

(72) Inventors: MARGRIT DANNENFELDT, NURNBERG (DE); MONIKA BLUMM, FEUCHT (DE); THOMAS FUHRMANN, LAUF/PEG. (DE); DOMINIK LEITZMANN, WEIHERHOF (DE)

(21) Appl. No.: 15/774,393

(22) PCT Filed: Nov. 8, 2016
(86) PCT No.: PCT/EP2016/076947

§ 371 Date: May 8, 2018

(30) Foreign Application Priority Data
Nov. 9, 2015 (DE) 10 2015 221 960.7

(51) Int. Cl. F02F 3/12; C09D 183/16; C08G 77/62; C09D 183/04; F02B 23/06

(52) U.S. Cl. CPC F02F 3/12; C09D 183/16; F05C 2253/12; C09D 183/04; F02B 23/0696; C08G 77/62

(57) ABSTRACT

Disclosed is a coating for reducing or preventing hot-gas oxidation of the piston in an internal combustion engine. Said coating comprises a polysilazane-based polymer.

### TECHNICAL FIELD

The present invention relates to the use of a polysilazane-based layer for reducing or preventing the oxidation of the piston in an internal combustion engine as well as a piston having this coating.

### PRIOR ART

Steel pistons become much hotter in the motor than aluminum pistons owing to their lower heat conductivity. The consequence of this is that different reactions are triggered on the steel surface. Thus, for example, an oxide layer is formed on the rim of the combustion bowl in the piston crown, which can become detached and thereby lead to a reduction of the material layer thickness at this point. In the worst case, the piston thereby becomes cracked which leads to a material failure.

So far, the consequences of this oxidation can only be countered by measures that are expensive or disadvantageous for other reasons. One possibility is a reinforced dimensioning of the piston, which makes it heavier. However, a low piston weight is advantageous for LVD pistons, i.e. pistons for diesel motors in passenger cars or light commercial vehicles.

A different possibility for reducing the oxidation is the use of special alloys having a high chrome and nickel content. However, such alloys are expensive. Moreover, a high chrome content interferes with the layer formation during the manganese phosphating and furthermore increases the effort involved in maintaining the bath. The application of a protective galvanic coating on the steel piston is also associated with high costs.

So far, polysilazane or polysiloxane-based coatings were used on pistons in order to either reduce the thermal conductivity or avoid oil-carbon cakings (see, for example, WO 2012/024415, US 2007/011382 and WO 2006/087113).

As a rule, such coatings are applied only in the cavities of the piston crown, the so-called cooling channels. This is supposed to prevent oil-carbon dogging the cooling channel so that the piston is cooled more poorly. The higher piston temperatures that occur thereby during operation can in turn lead to a mechanical failure of the piston.

The polysiloxane layers used in WO 2006/087113 are produced by a sol-gel process. However, this process leads to porous layers and therefore the layers are gas permeable and are not suited to avoiding the oxidation.

Unlike with oil-carbon cakings, the oxidation leads to problems, especially in the area of the rim of the combustion bowl, since the highest component temperatures and large mechanical loads occur at this point.

Due to the so far insufficient possibilities for preventing the hot-gas corrosion of the piston, there is a need for a coating which can be applied easily and cost-efficiently and which effectively prevents the hot-gas oxidation.

This object is solved according to the invention through the use of a polysilazane-based coating and through the special method of applying this coating.

### DETAILED DESCRIPTION OF THE INVENTION

The invention relates to the use of a coating which comprises a polysilazane-based polymer for reducing or preventing the oxidation of the piston in an internal combustion engine.

Within the scope of the invention, particularly the bowl rim and the adjacent surfaces which are most damaged by oxidation can be protected in advantageous ways, Therefore, according to the invention, preferably the rim of the combustion bowl and particularly the entire outer piston crown area is coated. In one particularly preferred embodiment, the entire piston crown including the combustion bowl is coated.

According to the invention, a coating is used which comprises a polysilazane-based polymer (also designated below as a polysilazane-based coating). An inorganic as well as an organic polysilazane can be used as a base. The inorganic polysilazane used according to the invention forms an amorphous network of Si and N atoms that has components of the formula —(H₂Si—NH)ₙ— and is also designated as perhydropolysilazane. In organic polysilazanes, the network is modified by organic groups, resulting in components of the formula —(R¹R²Si—NH)—. Of course, polymers containing inorganic as well as organic polysilazane units can also be used.

Poiysiiazane-based coatings are conventionally used for electronic components. The products that are commercially available for this can be used within the scope of the invention.

Solutions of perhydropolysilazane in solvents are used to form inorganic polysilazane. For example, 20% perhydropolysilazane in dibutyl ether (for example, from the company AZ Electronic Materials) can be used.

The organic polysilazanes can have different substituents R¹ and R², for example, a polysilazane modified with vinyl groups can be used. They can be dissolved in different solvents, for example, butyl acetate, These solutions can optionally contain further organic admixtures, Examples of suitable organic polysilazanes are HIT 1S00 (Merck KGaA) as well as HTA 1500 (KiON Defense Technologies).

The thickness of the coating is preferably 0.2 μm to 400 μm, with high layer thicknesses only being able to be produced as a rule by means of organic polysilazanes.

The thickness of the coating is preferably, particularly when using inorganic polysilazane, is 0.2 μm to 10 μm, and especially preferably 0.5 μm to 2 μm.

The reaction of the polysilazane with humidity, water or alcohol forms a polysiloxane layer, which in the case of the inorganic polysilazane is an amorphous quartz glass layer.

By means of the invention, particularly pistons of CrMo-alloyed steels are able to be effectively protected from oxidation. This has proven to be particularly advantageous for 42CrMo4 pistons. This alloy can normally only be used for low to medium loads since it is unacceptably quickly oxidized by hot-gas corrosion at high loads.

Furthermore, the present invention relates to a method for reducing or preventing the oxidation of the piston in an internal combustion engine. This method comprises applying the polysiloxane-based coating described above to an area of the piston. The application of the polysilazane to the piston can be performed, for example, by means of painting, pouring and spraying in the manner known to the person skilled in the art.

The composition applied this way is preferably heated to a temperature of 15° C. to 255° C. for cross-linking.

The polysilazane-based coating transforms in the following days under the influence of humidity, water or alcohol at least partially into a polysiloxane-based coating. The method according to the invention is performed in a particularly suitable manner such that the polysilazane network completely transforms into a polysiloxane network.

Contrary to the layers known in the prior art that are produced by means of a sol-gel process, the polysiloxane layer produced this way is not porous and therefore gas-tight so that an oxidation of the piston is prevented.

In one further embodiment, the invention relates to a piston in which at least the rim of the combustion bowl, more preferably the entire outer piston crown area, particularly the entire piston crown including the combustion bowl is provided with the polysilazane-based coating described above.

1-11. (canceled)

12. A method for reducing or preventing oxidation of a piston for an internal combustion engine, comprising coating at least a portion of the piston with polysilazane-based polymer coating.

13. The method of claim 12, including selecting a piston crown of the piston as a portion of the piston to be coated with the polysilazane-based polymer coating.

14. The method of claim 12, including selecting a rim of the combustion bowl as a portion to be coated with the polysilazane-based polymer coating.

15. The method of claim 12, including selecting an entire combustion bowl, including a rim of the combustion bowl, as a portion of the piston to be coated with the polysilazane-based polymer coating.

16. The method of claim 12, including selecting inorganic or organic polysilazane as the as a base of the polysilazane-based polymer coating.

17. The method of claim 16, including selecting inorganic polysilazane as the base.

18. The method of claim 12, including controlling the thickness of the applied coating to within 0.2 to 400 μm.

19. The method of claim 12, including controlling the thickness of the applied coating to within 0.2 to 10 μm.

20. The method of claim 12, including controlling the thickness of the applied coating to within 0.5 to 2 μm.

21. The method of claim 12, including selecting steel as the material for the piston to be coated.

22. The method of claim 21, wherein the steel for the piston is further selected as a CrMo-alloy of steel.

23. The method of claim 22, wherein the steel alloy of the piston is selected as 42CrMo4.

24. The method of claim 12, including crosslinking the polysilazane-based polymer coating at a temperature of 15° C. to 225° C.

25. The method of claim 24, including further transforming the the coating into a polysiloxane-based coating.

26. A steel piston having a combustion bowl with a rim, and wherein at least the rim is coated with a polysilazane-based polymer coating.

27. The steel piston according to claim 26, wherein the entire combustion bowl, including the rim, is coated with the polysilazane-based polymer coating.

28. The steel piston according to claim 26, wherein the piston is fabricated of CrMo-alloyed steel.

29. The steel piston according to claim 28, wherein the piston is fabricated of 42CrMo4 alloyed steel.
